(19) United States
(12) Patent Application Publication
(10) Pub. No.: US 2007/0131828 A1
(43) Pub. Date: Jun. 14, 2007

(54) Pad with suction units

(76) Inventor: Cheng-Kun Chang, Ta-Li City (TW)

Correspondence Address: MEREK, BLACKMON & VOORHEES, LLC, 673 SOUTH WASHINGTON STREET, ALEXANDRIA, VA, 22314, US

(21) Appl. No.: 11/296,491

(22) Filed: Dec. 8, 2005

(51) Int. Cl. F16B 47/00

(52) U.S. Cl. 248/205.5

(57) ABSTRACT

A pad includes: a pad body having upper and lower surfaces and formed with a plurality of spaced apart lower recesses, each of which is indented inwardly from the lower surface and each of which is defined by a recess-defining wall, the recess-defining wall having a base portion with a peripheral edge, and a surrounding portion that extends from the peripheral edge of the base portion to the lower surface; and a plurality of suction units, each of which protrudes outwardly from the base portion of the recess-defining wall of a respective one of the lower recesses.

### BACKGROUND OF THE INVENTION

1. Field of the Invention This invention relates to a pad, more particularly to a pad having suction units on a pad body.

2. Description of the Related Art

A suction unit is typically made of a resilient material, and is usually conical in shape. When the suction unit is brought into contact with and is pressed against a surface of an object, a portion of the air present between the suction unit and the surface of the object is removed, thereby creating a partial vacuum between the suction unit and the surface of the object and achieving a fixing effect. Because of such fixing effect, a suction unit has been applied to several objects, such as pads, hangers, dolls, etc.

However, a conventional pad having suction units suffers from some problems. As shown in FIG. 1, a conventional pad 9 includes a pad body 91 having upper and lower surfaces 912 and 911, and a plurality of suction units 92 provided on the lower surface 911 of the pad body 91.

Referring to FIG. 2, as the pad 9 is pressed by an external force (F1), the suction units 92 deform, and the air is removed from a space 920 confined between each suction unit 92 and a surface 10 of an object to be adhered, thereby adhering the end portion 921 of each suction unit 92 to the surface 10 of the object. However, it should be noted that, under such suction state, the suction units 92 are extremely deformed such that the upper surface 912 of the pad 92 is pulled downward to result in an uneven surface of the pad 9.

Furthermore, if the pad 9 is pressed by another force (F2) applied to a location 913 between adjacent suction units 92, the end portion 921 of each of the suction units 92 is likely to detach from the surface 10 of the object (see FIG. 2), thereby resulting in deterioration of the fixing effect.

### SUMMARY OF THE INVENTION

Therefore, the object of the present invention is to provide a pad that can overcome the aforesaid problems of the prior art.

According to this invention, a pad comprises: a pad body having upper and lower surfaces and formed with a plurality of spaced apart lower recesses, each of which is indented inwardly from the lower surface and each of which is defined by a recess-defining wall, the recess-defining wall having a base portion with a peripheral edge, and a surrounding portion that extends from the peripheral edge of the base portion to the lower surface; and a plurality of suction units, each of which protrudes outwardly from the base portion of the recess-defining wall of a respective one of the lower recesses.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a fragmentary schematic sectional view illustrating a conventional pad having suction units;

FIG. 2 is a fragmentary schematic sectional view illustrating a state where the conventional pad of FIG. 1 is adhered to a surface of an object (i.e., a state of use);

FIG. 3 is a top perspective view showing the preferred embodiment of a pad according to this invention;

FIG. 4 is a bottom perspective view showing the preferred embodiment of the pad according to this invention;

FIG. 5 is an enlarged fragmentary top perspective view of the preferred embodiment of the pad according to this invention;

FIG. 6 is an enlarged fragmentary bottom perspective view illustrating the structure of the pad according to this invention;

FIG. 7 is a fragmentary schematic sectional view illustrating the preferred embodiment of the pad according to this invention in a non-use state; and

FIG. 8 is a fragmentary schematic sectional view illustrating the preferred embodiment of the pad according to this invention in a state of use.

### DETAILED DESCRIPTION OF THE PREFERRED EMBODIMENT

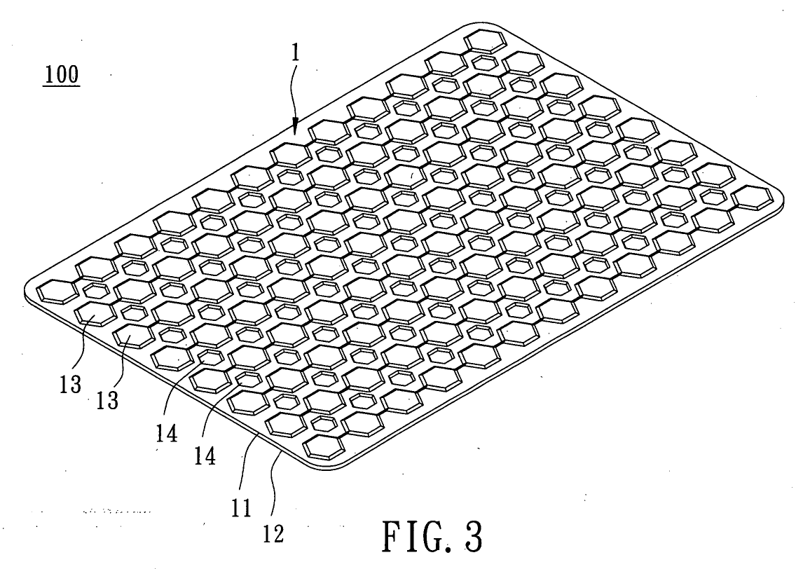

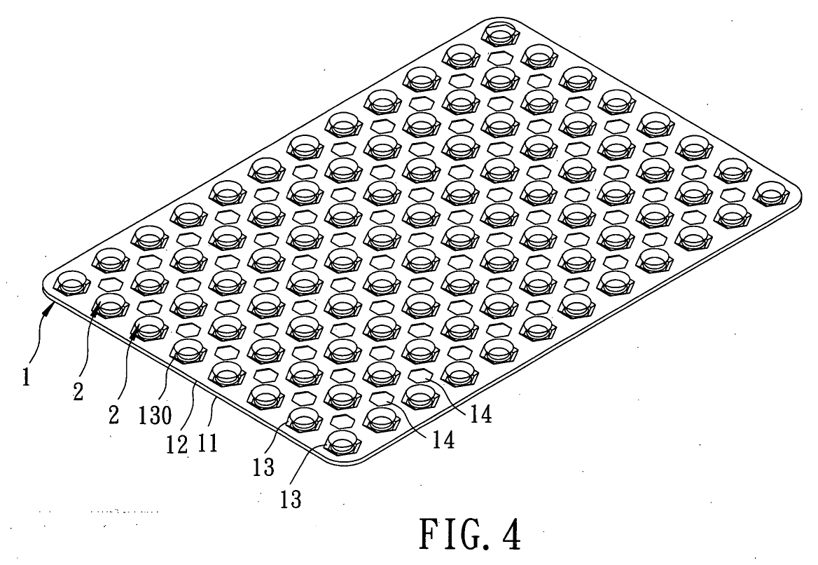

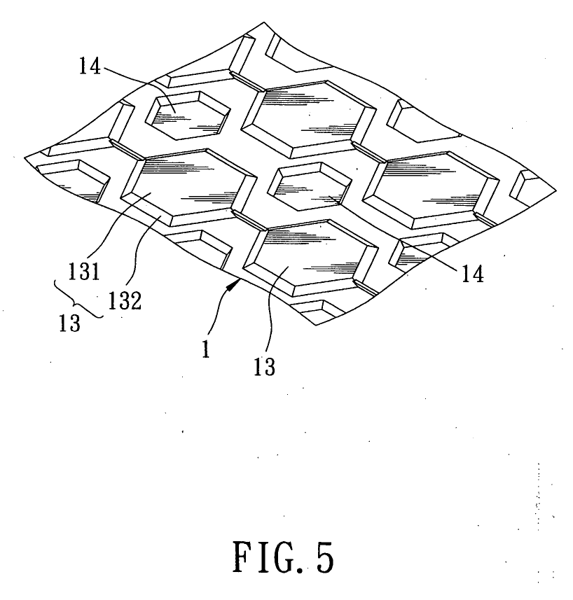

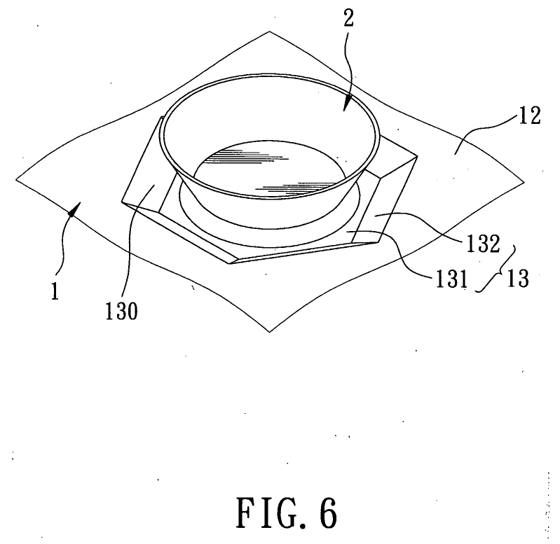

Referring to FIGS. 3 to 6, the preferred embodiment of a pad 100 according to this invention includes a pad body 1 having upper and lower surfaces 11 and 12, and a plurality of suction units 2. A plurality of spaced apart lower recesses 130 are formed in the lower surface 12 of the pad body 1. Each of the lower recesses 130 is indented inwardly from the lower surface 12, and is defined by a recess-defining wall 13. The recess-defining wall 13 has abase portion 131 with a peripheral edge, and a surrounding portion 132 that extends from the peripheral edge of the base portion 131 to the lower surface 12 of the pad body 1. Each of the suction units 2 protrudes outwardly from the base portion 131 of the recess-defining wall 13 of a respective one of the lower recesses 130.

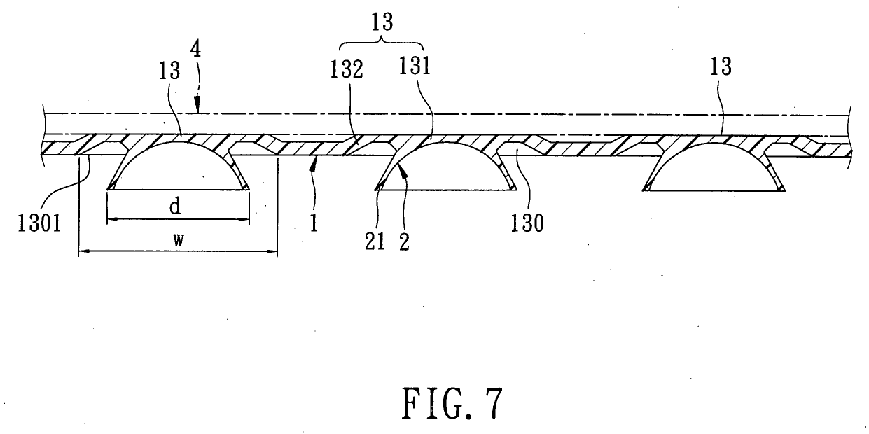

As shown in FIG. 7, each of the suction units 2 is typically conical in shape, and has an open end 21 disposed outwardly of the respective one of the lower recesses 130. The surrounding portion 132 of the recess-defining wall 13 of each of the lower recesses 130 defines an open end 1301 distal from the base portion 131 and having a diameter (w) greater than the diameter (d) of the open end 21 of the respective one of the suction units 2.

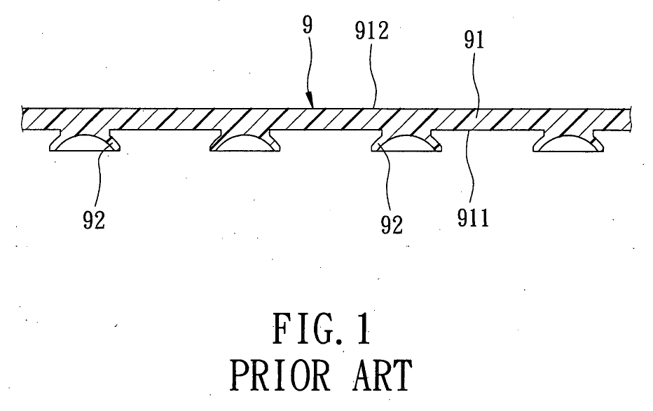

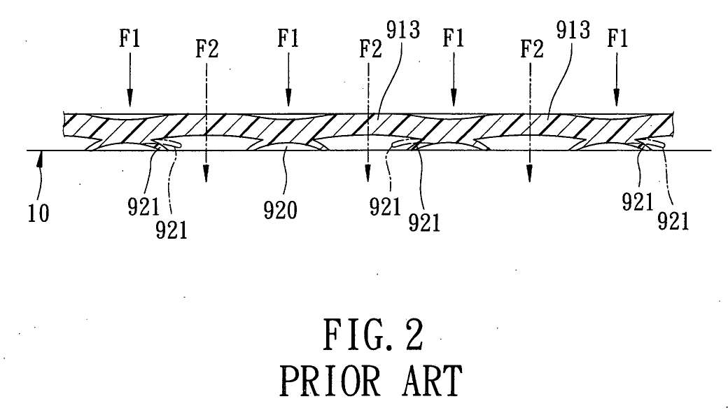

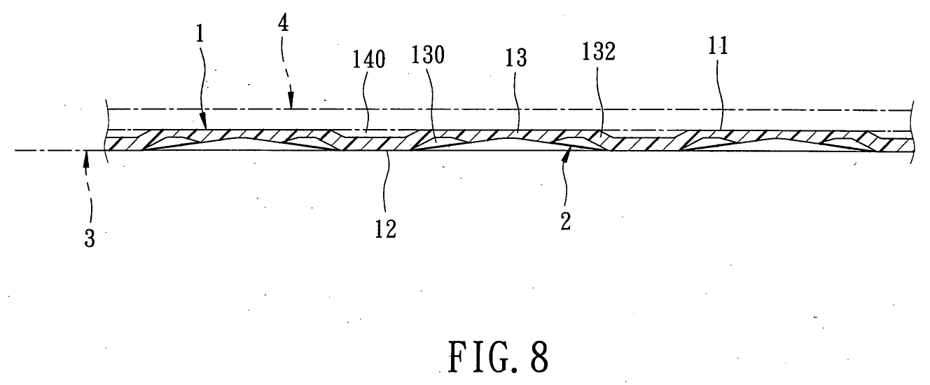

FIG. 8 illustrates the preferred embodiment of the pad 100 according to this invention in a state of use. Referring to FIGS. 7 and 8, when an external force is applied to press the pad 100 against a surface of an object 3, each of the suction units 2 deforms and is retracted into the respective one of the lower recesses 130. The deformation of each of the suction units 2 is stopped as the open end 21 of each of the suction units 2 abuts against the open end 1301 of the surrounding portion 132 of the recess-defining wall 13 of the respective one of the lower recesses 130, and the lower surface 12 of the pad body 1 abuts against the surface of the object 3. In the meantime, the open end 21 of each of the suction units 2 is flush with the lower surface 12 of the pad body 1. Unlike the aforesaid conventional pad body 91 of FIGS. 1 and 2, the upper surface 11 of the pad body 1 remains flat after the pressing action.

In this embodiment, each of the suction units 2 is integrally connected to the base portion 131 of the recess-defining wall 13 of the respective one of the lower recesses 130.

In addition, the recess-defining wall 13 of each of the lower recesses 130 protrudes from the upper surface 11 of the pad body 1 so as to form an upper recess 140 (see FIG. 8) in the upper surface 11 that surrounds the recess-defining wall 13. Hence, even when the upper surface 11 of the pad body 1 is deformed so as to form a slight concave portion on the upper surface 11 due to the pressing action, the concave portion is substantially flush with the surface of the upper recess 140, thereby further alleviating the uneven problem as encountered in the prior art.

In this embodiment, the pad body 1 is further formed with a plurality of through-holes 14 therethrough (see FIG. 3), thereby reducing the weight of the pad 100.

In addition, the pad 100 of this invention further includes a decorative sheet 4 (see FIG. 7) provided on the upper surface 11 of the pad body 1.

By forming the lower recesses 130 in the lower surface 12 of the pad body 1, and by providing each of the suction units 2 in a respective one of the lower recesses 130, the aforesaid uneven and undesired detaching problems associated with the prior art can be alleviated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A pad comprising:
a pad body having upper and lower surfaces and formed with a plurality of spaced apart lower recesses, each of which is indented inwardly from said lower surface and each of which is defined by a recess-defining wall, said recess-defining wall having a base portion with a peripheral edge, and a surrounding portion that extends from said peripheral edge of said base portion to said lower surface; and
a plurality of suction units, each of which protrudes outwardly from said base portion of said recess-defining wall of a respective one of said lower recesses.

2. The pad of claim 1, wherein each of said suction units is integrally connected to said base portion of said recess-defining wall of the respective one of said lower recesses.

3. The pad of claim 1, wherein each of said suction units is conical in shape, and has an open end disposed outwardly of the respective one of said lower recesses, said surrounding portion of said recess-defining wall of each of said lower recesses defining an open end distal from said base portion and having a diameter greater than that of said open end of the respective one of said suction units.

4. The pad of claim 3, wherein each of said suction units is deformable from a non-use state to a state of use in which each of said suction units is retracted into the respective one of said lower recesses such that said open end of each of said suction units is flush with said lower surface of said pad body.

5. The pad of claim 3, wherein each of said suction units is deformable from a non-use state to a state of use in which each of said suction units is retracted into the respective one of said lower recesses such that said open end of each of said suction units abuts against said open end of said surrounding portion of said recess-defining wall of the respective one of said lower recesses.

6. The pad of claim 1, wherein said recess-defining wall of each of said lower recesses protrudes from said upper surface of said pad body so as to form an upper recess in said upper surface that surrounds said recess-defining wall.

7. The pad of claim 1, wherein said pad body is further formed with a plurality of through-holes therethrough.

8. The pad of claim 1, further comprising a decorative sheet provided on said upper surface of said pad body.
